(19) United States
(12) Patent Application Publication
(10) Pub. No.: US 2024/0237587 A1
(43) Pub. Date: Jul. 18, 2024

(54) AGRICULTURAL SYSTEM, DEVICE AND METHOD

(71) Applicant: Phyllome IP Pty Ltd, Alexandria (AU)

(72) Inventors: Sebastien Eckersley-Maslin, Surry Hills (AU); Katharyn Moger, Surry Hills (AU)

(73) Assignee: Phyllome IP Pty Ltd, Alexandria (AU)

(21) Appl. No.: 18/561,393

(22) PCT Filed: May 9, 2022
(86) PCT No.: PCT/AU2022/050434

§ 371 Date: Nov. 16, 2023

(30) Foreign Application Priority Data
May 17, 2021 (AU) 2021901455

(51) Int. Cl. A01G 7/04; A01G 31/06

(52) U.S. Cl. CPC A01G 7/045; A01G 31/06

(57) ABSTRACT

An embodiment provides an agricultural system comprising a plurality of trays, each tray being suitable for holding a substrate in which a crop can grow, a structure for supporting the plurality of trays in a stacked arrangement, the system further comprising a lighting system for delivering light to the crops and a nutrient supply system for supplying nutrients to the crops and at least one service module for lifting a selected tray and for moving the selected tray relative to the frame and the other trays along any one of a plurality of preconfigured paths, wherein the service module comprises an internal power source for powering said lifting of the selected tray and moving of the selected tray along a path.

### TECHNICAL FIELD

Embodiments relate to agricultural systems, devices and methods.

### BACKGROUND

Modern farming techniques have evolved together with the advent of recent developments in other technologies. A relatively recent advancement is the introduction of so-called “vertical farms” which attempt to stack crops in an arrangement which extends both horizontally and vertically.

Potential gains from vertical farms take advantage of the additional space that the vertical extension brings, thereby allowing for a potentially significant increase in yield per square meter of land surface and the ability to enclose the growing volume to increase the sterility of that volume. However, these farms suffer from a number of technical challenges including problems associated with delivering the requisite light and nutrients to plants no longer situated on the ground.

### SUMMARY OF THE DISCLOSURE

An embodiment provides an agricultural system comprising a plurality of trays, each tray being suitable for holding a substrate in which a crop can grow, a structure for supporting the plurality of trays in a stacked arrangement, the system further comprising a lighting system for delivering light to the crops and a nutrient supply system for supplying nutrients to the crops and at least one service module for lifting a selected tray and for moving the selected tray relative to the frame and the other trays along any one of a plurality of preconfigured paths, wherein the service module comprises an internal power source for powering said lifting of the selected tray and moving of the selected tray along a path.

The structure and the service modules may be configured so that the service module is positioned below the selected tray prior to lifting.

The service module may comprise a lifter for engaging the selected tray from below and lifting and lowering the selected tray.

The lifter may comprise one or more sets of arms arranged in a scissor formation.

The lifter may comprise one or more sets of screw actuators. The screw actuators may be arranged near respective corners of the service module.

The stacked arrangement may extend both horizontally and vertically. The plurality of trays may be arranged in a plurality of rows. The rows may be arranged vertically and/or horizontally. When the rows are arranged horizontally, they may be arranged adjacent to one another.

The system may further comprise a plurality of service modules. Each service module may be configurable to lift and move a selected tray along a preconfigured path wherein a first preconfigured path for a first service module is distinct from a second preconfigured path for a second service module. Where there are a plurality of service modules, the service modules may be interchangeable. Each service module may be programmable.

Each service module may comprise at least one camera. The camera may be directed downwards so that the camera is able to capture image information relating to crops located below the service module.

The camera may capture image information in the visual band. The camera may additionally, or instead, capture image information in the ultra-violet and/or infra-red bands.

The service module may comprise a carbon dioxide sensor. The service module may comprise a temperature sensor. The service module may comprise a humidity sensor.

Each tray may comprise a label. Each label may be unique. In one embodiment, the label is an RFID chip. The service module may then comprise a label reader for identifying each tray by the corresponding label. In an embodiment, the label reader comprises an RFID reader.

One or all of the service modules may be adapted to lift the selected tray prior to moving it. The service module may be adapted to first lift and then move the selected tray. The service module may be adapted to lower the tray after moving the tray.

The lifter may comprise two arms located proximate corresponding distal ends of the service module. The arms may be mounted to pivot relative to one another in a scissor arrangement.

The service module may comprise a locomotion system. The locomotion system may comprise a plurality of wheels at least one of which is powered by the internal power source.

The service module may comprise an odometer for measuring a distance travelled by the service module. The odometer may comprise an optical encoder to determine an angular rotation of a wheel of the service module.

The service module may comprise a brake. The brake may comprise a regenerative braking system.

The service module may comprise a blowing arrangement for blowing air downwards as the service module moves.

The agricultural system may comprise one or more stations. The one or more stations may be one or more of a harvesting station, a cleaning station and a planting station. The one or more station may be spaced from the structure.

The one or more service modules may transport the trays between the structure and the one or more stations, and between the stations where there is more than one station.

The system may comprise one or more rails defining paths for the service module. The rails may comprise C-section beams. The service module wheels may be adapted to travel within the C of the C-section beams. In an alternate embodiment, other rails may be used, for example, Z-section beams may be used instead.

The rails may additionally support the trays within the structure. The rails may support the trays when the trays are at rest.

The system may comprise one or more service module lifts to move the service modules vertically relative to the structure. The service module lifts may act to move the tray to different rows in the structure.

The preconfigured paths may comprise movement of a service module relative to the rails and vertical movement with the use of one or more service module lifts.

The system may be configured to separate the nutrients from the service module. The system may include one or more drains for catching liquids draining from the trays wherein the drains are spaced from the rails.

A further embodiment provides an agricultural system comprising a plurality of trays, each tray being suitable for holding a substrate in which a crop can grow, a structure for supporting the plurality of trays in a stacked arrangement, the system further comprising a lighting system for delivering light to the crops and a nutrient supply system for supplying nutrients to the crops and at least one service module for lifting a selected tray and for moving the selected tray relative to the frame and the other trays along any one of a plurality of preconfigured paths, wherein the structure and the service modules are configured so that the service module is positioned below the selected tray prior to lifting and wherein the service module comprises a lifter for engaging the selected tray from below and lifting and lowering the selected tray.

A further embodiment provides an agricultural system comprising a plurality of trays, each tray being suitable for holding a substrate in which a crop can grow, a structure for supporting the plurality of trays in a stacked arrangement, the system further comprising a lighting system for delivering light to the crops and a nutrient supply system for supplying nutrients to the crops, the nutrient supply system comprising at least one reservoir and a plurality of outlets, each outlet corresponding to a tray location, the system further comprising a plurality of valves for selectively allowing liquid nutrients stored in the reservoir to be delivered to one or more specified tray locations via corresponding outlets, wherein each of the valves is configured to store an operational schedule and to implement the schedule on demand when a tray is positioned for receiving said nutrients from a selected valve.

The agricultural system may comprise two or more reservoirs arranged so that each reservoir is selectively connectable to a plurality of the outlets.

A further embodiment extends to a method of moving a tray within an agricultural system, the agricultural system comprising a plurality of trays, each tray being suitable for holding a substrate in which a crop can grow, a structure for supporting the plurality of trays in a stacked arrangement, the system further comprising a lighting system for delivering light to the crops and a nutrient supply system for supplying nutrients to the crops and at least one service module, the method comprising lifting a selected tray from below using a service module positioned below the tray and using the service module to move the selected tray relative to the frame and the other trays along any one of a plurality of preconfigured paths.

The method may comprise locating the service module under the tray and then using the service module to lift the selected tray. The service module may be self-powered. The service module may be adapted to lift and move a single tray.

The structure may extend both vertically and horizontally and define the plurality of preconfigured paths, at least one of which comprises a vertical component, wherein the method may comprise lifting the tray to follow the vertical component of the preconfigured path.

The method may further comprise using the service module to collect data relating to the agricultural system while the service module moves through the system.

The data collected by the service module may include one or more of images, temperature, carbon dioxide concentration, lighting intensity and/or colour, humidity, etc.

The service module may further comprise a blower in which case the method may further comprise blowing air downwards using the blower as the service module moves through the structure.

A further embodiment extends to a method of delivering nutrients in an agricultural system, the agricultural system comprising a plurality of trays, each tray being suitable for holding a substrate in which a crop can grow, a structure for supporting the plurality of trays in a stacked arrangement, the system further comprising a lighting system for delivering light to the crops and a nutrient supply system for supplying nutrients to the crops, the nutrient supply system comprising at least one reservoir and a plurality of outlets, each outlet corresponding to a tray location, the system further comprising a plurality of valves for selectively allowing liquid nutrients stored in the reservoir to be delivered to one or more specified tray locations via corresponding outlets, each of the valves is configured to store an operational schedule and to implement the schedule on demand when a tray is positioned for receiving said nutrients from a selected valve, the method comprising:
sending an operational schedule to each of valves, the operational schedule specifying a schedule for delivering liquid nutrients to a tray;
locating a selected tray relative to a selected valve of the plurality of valves so that the selected valve is able to deliver liquid nutrients to the selected tray;
activating the selected valve so that the valve delivers liquid nutrients to the selected tray according to the operational schedule.

The operational schedule may be stored on each of the valves.

The method may further comprise removing the selected tray and deactivating the selected valve. The selected valve may be deactivated after removal of the selected tray.

The method may comprise activating each valve having a corresponding tray associated therewith for delivery of liquid nutrients so that each activated valve operates according to the operational schedule and deactivating each valve not having a corresponding tray associated therewith.

The operational schedule may specify different operating schedules for different valves in different locations.

### DESCRIPTION OF THE DRAWINGS

Embodiments are herein described, with reference to the accompanying drawings in which:

FIG. 1 is a schematic overview of an agricultural system according to an embodiment;

FIG. 2 is a perspective view of a structure for use with the system of FIG. 1;

FIG. 3 is a side view of the structure of FIG. 2;

FIG. 4 is a perspective view of a tray insert according to an embodiment;

FIG. 5 is a perspective view of a tray according to an embodiment;

FIG. 6 is a perspective view of a service module for use with the system of FIG. 1;

FIG. 7 is a right side view of the service module of FIG. 6;

FIGS. 8A and 8B are views of the innards of the service module of FIG. 6 showing details;

FIGS. 9A and 9B show the service module of FIG. 6 lifting a tray;

FIG. 10 is a portion of a nutrient supply system for use with the system of FIG. 1;

FIG. 11 is a further portion of the nutrient supply system partially shown in FIG. 10; and

FIG. 11 is a portion of a further nutrient supply system for use with the system of FIG. 1.

### DETAILED DESCRIPTION OF SPECIFIC EMBODIMENT

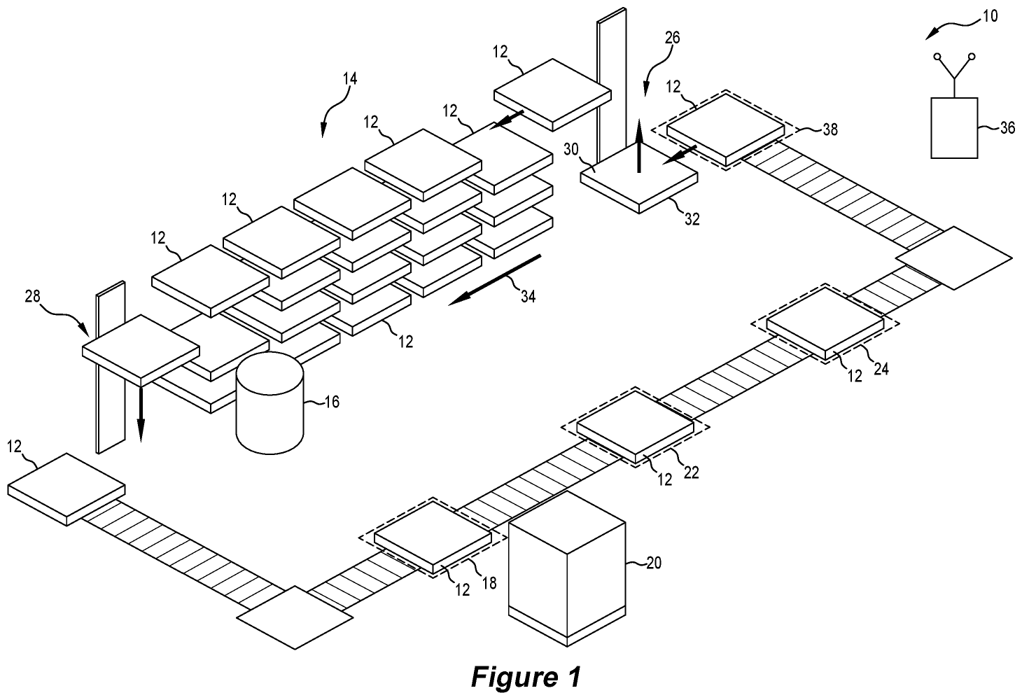

FIG. 1 a schematic overview of an agricultural system 10 according to an embodiment. The system 10 is an agricultural system which uses a vertical arrangement for crop growing. In this embodiment, the crops are grown and transported in trays 12. A number of trays 12 (only some of which are labelled in FIG. 1) are stacked in rows which extend horizontally and columns which extend vertically in a structure 14.

The structure 14 provides the crops in the trays 12 with light and nutrients (water and other nutrients such as fertilizer). A nutrient tank 16 is connected by a series of pipes and valves (not shown in FIG. 1) to deliver nutrients stored in the tank to the crops growing in the trays 12. The structure 14 is divided into tray locations and the trays are moved from location to location, where each location is provided with an outlet for providing the tray situated at that locations with nutrients from the nutrient tank 16 and light from light sources situated above that location.

As shown schematically in FIG. 1, the structure 14 comprises four rows and five columns. For all rows, the lights will be provided at the bottom of the row above.

In addition to the structure 14, the system 10 illustrated in FIG. 1 includes a harvesting station 18, a weighing and packing station 20, a washing station 22, a seed station 24, an onboard lift 26 and an offboard lift 28. In general terms, once the crops have been fully grown in the structure 14, the crops are harvested as the harvesting station 18 and moved to the weighing and packaging station 20 where they are prepared for further distribution, for example to a supermarket or distribution centre. The now-empty tray 12 is then washed in the washing station 22 and filled with new seeds and a substrate to hold the seeds where necessary at the seeding station 24. An onboard lift 26 will then move the tray to the correct row (if necessary). Similarly, an off board lift 28 is able to lower the trays 12 from the upper rows down.

In order to move through the system and allow processing of the crops and trays at the various stations provided, the trays themselves are moved through the system. This movement is achieved by one or more service modules 30 which uses a set of wheels 32 to move the service module 30 along rails (not shown in FIG. 1).

As crops grow the trays are moved down their corresponding row in the structure in the direction of arrow 34 so that newly planted crops are closest to the onboard lift 26 and those ready for harvesting are closest to the offboard lift. Movement of the trays 12 through the structure 14 as well as between the various stations is carried out by the service modules 30.

A central server 36 controls the movements of the service modules 30 and collects and collates all the data from the service modules. In addition, the central server controls the nutrient deliver system which includes the nutrient tank 16 as well as all the pumps and valves.

It is to be realised that FIG. 1 is schematic and does not illustrate details of embodiments, but is intended to give a broad overview of the system 10 and its general operation. Further details are described in subsequent Figures.

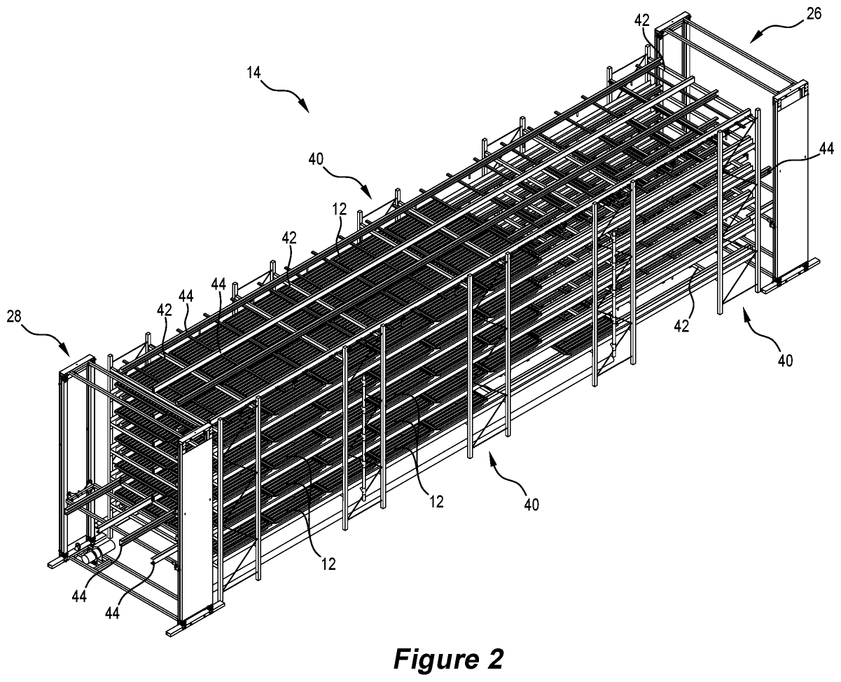

FIG. 2 illustrates the structure 14 in greater detail. The structure 14 is comprised of a set of vertical supports 40 and cross-beams 42. Rails 44 are attached to the cross beams. As illustrated, the rails 44 are comprised of C-section beams orientated so that the rails are formed by two C-section beams with the open portion of the “C” facing one another. In this manner the wheels of the service modules are able to run inside opposing pairs of the rails 44.

In this embodiment, the structure 14 comprises six rows, with each row comprising two adjacent sets of tray locations (as shown by the four rails 44 for each row).

The onboard lift 26 lifts service modules (whether carrying trays or not) to the respective rail set in the selected row, and the offboard lift 28 lowers the trays again. As illustrated, the lowermost sets of rails extend out past the ends of the structure where the onboard 26 and offboard 28 lifts are located. These rails 44 extend out in both directions (although not illustrated in FIG. 2) and form the track to the various stations discussed above with reference to FIG. 1 (it is to be realised that a portion of the illustrated rails 44 at this location form a part of the two lifts so that the service modules can be lifted and lowered).

The onboard 26 and offboard 28 lifts operate in a known manner and will not be further described herein.

The topmost set of rails are used for temporary storage if it is necessary to move a tray located in the middle of a row, as explained in further detail below.

The structure 14 also supports the piping needed for the nutrient system which will be described in greater detail below.

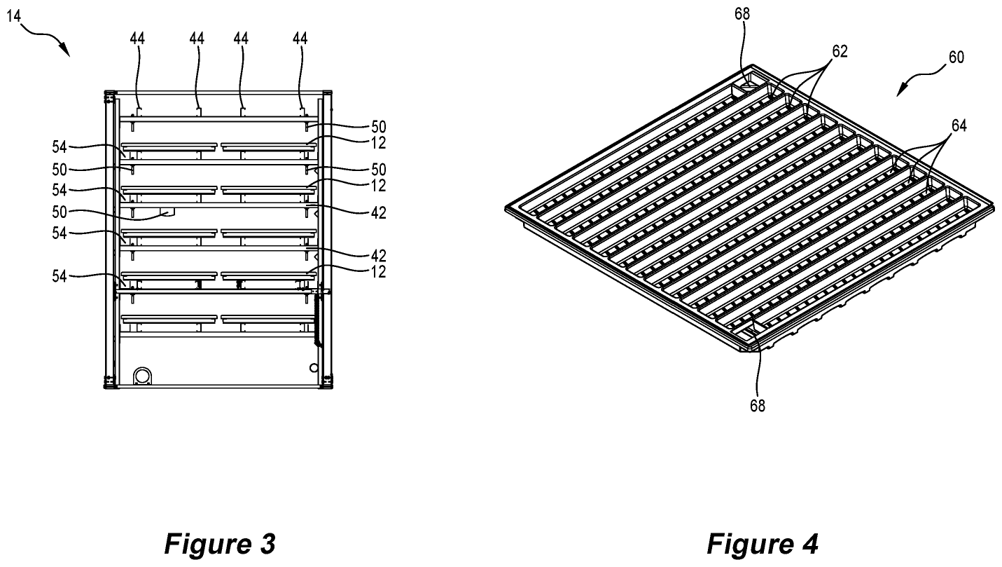

FIG. 3 illustrates a side view of the structure 14 of FIG. 2. The C-section of the beams forming the rails 44 are clearly visible. The trays 12 rest on top of the rails 44. Each tray 12 is located at a tray location which is a resting location in the structure 14 for a tray and which provides light and nutrients to the tray. An outlet 50, here in the form of a spray nozzle, is attached to the nutrient supply system and delivers nutrients to the tray at the respective location.

For the sake of clarity, the light sources have not been illustrated in FIGS. 2 and 3. However, the position of a light source when installed is illustrated at FIG. 3 in dashed outline 52. Each tray location is provided with a light source and each light source may be individually controlled so that the amount and type of light delivered to the respective location may be controlled. In this manner the growing cycle of the specific crops may be enhanced and controlled.

FIG. 4 illustrates an insert 60 for use with the tray 12. A set of ridges 62 provide a set of troughs 64 there between. The troughs 64 then provide a location for the crops and voids 66 formed in the bottom of the insert 60 provide runoff for water and nutrients. At two diagonally opposite corners, the insert 60 comprises two wells 68 which, in use, collect the water and other nutrients delivered to the tray 12 (in the manner disclosed below). The wells are formed with small apertures which allow the liquid to drip or flow out at a relatively reduced rate, ensuring that the roots of the crops are provided with sufficient exposure to the water and nutrients.

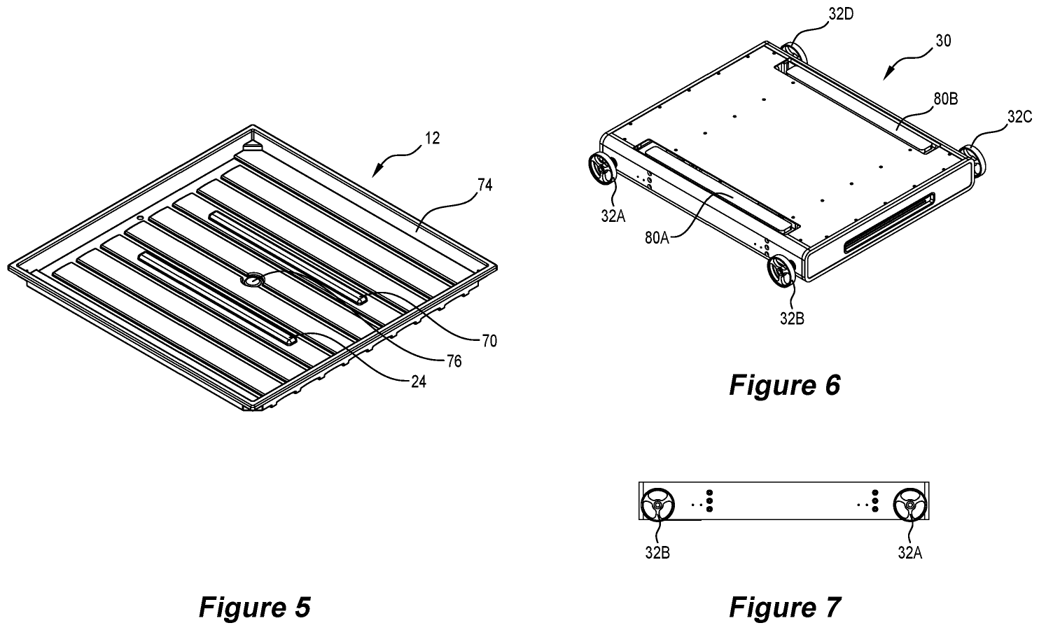

FIG. 5 illustrates a tray 12 for use with the system 10. The tray 12 is formed with two ridges 70 and 72, and an outer lip 74. The insert 60 (FIG. 4) is located in the tray and rests on the ridges 70 and 72, and within the void formed by the outer lip 74. The ridges 70 and 72, and outer lip 74, thereby form a pool for water and nutrients to collect and a space into which the roots of the crops extend down so that they are able to absorb water and nutrients when needed.

The tray 12 is formed with voids to allow the liquid which passes from the apertures in the wells 68 to drain from the tray 12. Referring back to FIG. 3, the structure 14 is provided with drains 54 in the form of a U-shaped pipe running alongside, and under, the edges of the trays 12. Although only one U-shaped drain is shown in FIG. 3, it is to be realised that a further drain is provided for the trays on the right hand side of FIG. 3.

The arrangement of the voids in the trays 12 and the drains 54 relative to the rails 44 helps to keep the liquid and the service modules separate, thereby potentially reducing the risk of the service modules becoming wet which may affect the operation or service life of the service modules.

The tray 12 is further formed with a central disc-shaped housing 76. The disc-shaped housing 76 houses an RFID chip which is used to identify the tray 12 in the manner described below.

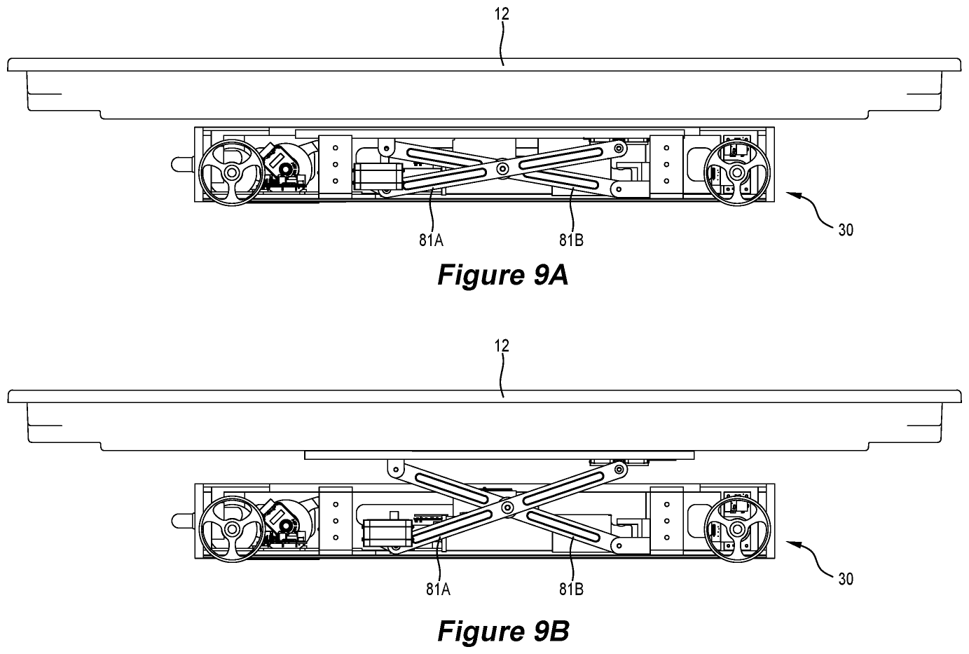

FIGS. 6, 7, 8 and 9 illustrate a service module 30 for use with the system 10. The service module 30 comprises four wheels 32A, 32B, 32C and 32D. Two scissor mechanisms 80A and 80B are provided toward either side of the service module 30 and act to lift and lower trays 12. As illustrated in FIG. 7, each scissor mechanism comprises two arms (the arms 81A and 81B of mechanism 80A are shown in FIGS. 9A and 9B). The two arms are mounted for central pivotal movement relative to one another in the known manner to provide lift.

In a further embodiment, the service module includes four screw actuators which act to lift and lower the tray. These screw actuators are located at respective corners of the service module.

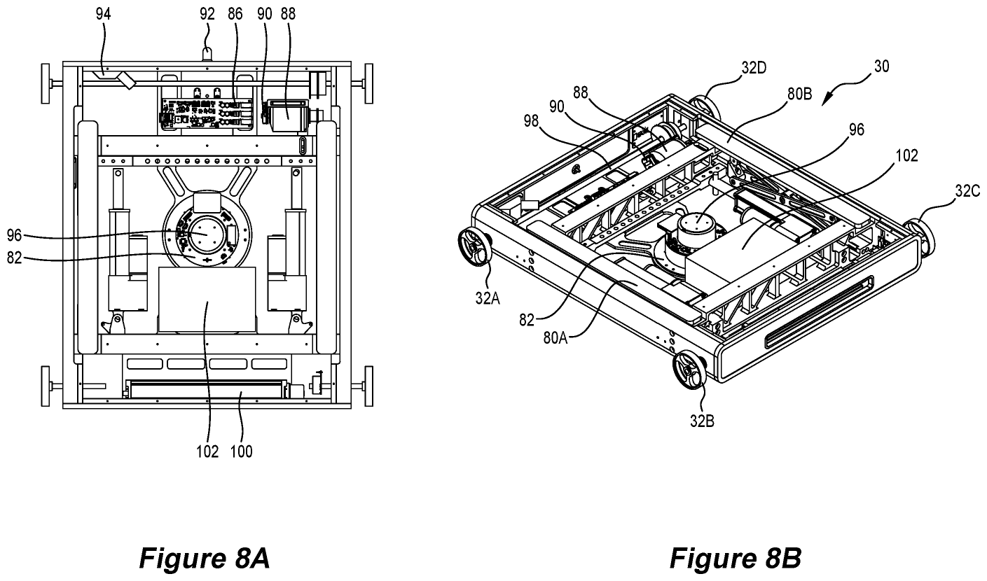

FIGS. 8A and B illustrate the innards of the service module 30. The service module 30 includes a camera situated in a camera housing 82. The lens of the camera is centrally located on the underside of the service module 30 so that the lens has a view over the tray located below the service module's current position. Therefore, as the service module 30 moves through the structure 14 it is able to capture images for all trays situated underneath the service module.

By providing a moveable service module 30 which moves through the structure 14 and which includes a camera, it may be possible to obtain images of all the crops in the structure 14 without providing a camera for each tray location in the structure 14, or providing a set of stationary cameras and attempting to ensure that all tray locations are covered by the cameras' fields of view. This, in turn, may significantly reduce the number of cameras and the associated cost. Furthermore, the camera which is provided on the service module may be more capable since the cost of supply and maintenance for cameras for the system as a whole may have been significantly reduced. In the illustrated embodiment, the camera provided on the service module is a high-resolution camera able to capture images in both the visual and infra-red spectrum so that relatively detailed images of all crops being grown may be obtained by moving the service module 30 through the system 10.

The service module 30 comprises a printed circuit board (PCB) 86 which includes further sensors as well as a drive motor controller and a controller (described in further detail below). It is to be realised that the service module 30 may be provided with additional sensors not illustrated such as a contactless temperature sensor provided on the camera assembly 82. In addition, the service module 30 may be provided with carbon dioxide, nitrogen and oxygen sensors, as well as other known sensors. Since the service module 30 moves through the structure 14 and its relative position within the structure is known, the service module 30 may be provided with additional sensors for making local measurements as it moves.

The service module 30 further comprises a vertical air curtain blower 100 which blows a curtain of air downwards as the service module moves over crops to potentially prevent stagnant air from settling over those crops. Providing such a blowing arrangement which blows a curtain of air downwards may reduce the boundary effect on the leaves, replenishing the surface area of the leaf with CO₂ enriched air and thus potentially increasing photosynthesis).

Wheels 32A and 32D, connected by axle 98, are driven by motor 88. Battery 102 provides power to the drive motor 88, and to the various sensors, PCBs and other components of the service module 30 requiring power. In this respect, the service module 30 is entirely self-powered and does not require the provision of an external power source for routine operations. However, it is to be realised that the service module 30 may be provided with a docking station which includes a connection to mains power to recharge the battery 102 when the service module is not otherwise being used.

Drive motor 88 has an optical position sensor 90 attached thereto. The position sensor 90 determines the position of the drive motor 88. Since the rotation position of the drive motor 88 can be determined and the position of the service module is related to the number of rotations of the wheels, the horizontal position of the service module 30 in the system 10 can be determined. Furthermore, if it is known in which row the service module is located the precise position of the service module may be determined.

By knowing the relative position of the service module relatively precisely it is not necessary to physically delimit the tray locations. Instead these locations (which correspond to light and nutrient delivery locations) can be defined in software.

The service module 30 further comprises a tray position sensor 96 which in this embodiment is an RFID chip reader. The reader 96 interacts with the RFID chips contained in the disc-shaped enclosures 76 in the trays 12 (see FIG. 5, for example). In this manner, the service module is able to identify the tray 12.

A drive motor controller (located on PCB 86) is connected to the drive motor 88 and controls the motion (and therefore relative position) of the service module 30. A controller (also located on PCB 86) collates the information produced by the sensors located on the service module such as the camera, edge sensor 94 reader 96, and communicates with the central server 36 to which it passes this information and receives instructions. The service module 30 comprises a network antenna 92 connected to the necessary hardware (e.g. Wi-Fi hardware) to enable network communication with the central server 36. An edge detector 94 detects when the service module 30 encounters an edge in the track and may be used to avoid the service module falling off the end and to calibrate position (using the position sensor 90). By knowing the positions of the edges and using the position sensor 90, a map is built up of the entire structure where the position of each tray is provided as a co-ordinate within the structure.

FIGS. 9A and 9B illustrate the lifting of a tray 12 by the service module. As shown in FIG. 8A, the service module 80 positions itself underneath the tray 12. Although not illustrated in FIGS. 9A and 9B, the tray 12 rests on top of the C-sections 44 (FIG. 3) which form the track along which the service module moves. The service module 30 is able to detect the presence of the tray 12 by using the reader 96 to read the RFID chip in housing 76. This, together with the map of the structure 14 built up using the information from the position sensor 90, allows the service module to position itself directly underneath the tray. Once in position, the service module 30 activates the scissor arms (arms 81A and 81B are illustrated in FIGS. 9A and 9B) to lift the two mechanisms 80A and 80B to the position shown in FIG. 9B. In doing so, the mechanisms 80A and 80B engage with the underside of the tray 12 and lift it.

In embodiments, lifting the tray from below may leave the space above the trays free for the placement of lighting, nutrient release valves and other supporting infrastructure. In addition, such an arrangement may help to provide a structure with modular roles that is easy to construct: the tracks act as the resting structure for the trays. In addition, the growth of the plants in the trays may be unencumbered by any overhead structures and the tracks may support lights and other system components—potentially reducing the overall cost.

The operation of the system 10 will now be described, primarily with reference to FIG. 1. The trays 10 are moved through the system 10 by the service modules 30. In the accompanying Figures a single service module 30 has been illustrated, but it is to be realised that more than one service module may be used and that the number of service modules will depend on the size of the system 10.

The central server 36 collates information regarding the system and sends commands to the service modules 30, lifts 26 and 28, nutrient system (see below) and other aspects of the system 10 which may be centrally controlled such as lighting. In the embodiment illustrated in FIG. 1, service modules do not move the trays between the various stations, although in a different embodiment, service modules may be used for this purpose. At loading station 38 the tray which is ready to be moved onto the structure 14 is loaded onto a service module by first resting the tray on top of the rails (such as the rails 44 illustrated in FIG. 2), having the service module 30 position itself under the tray 12, raise the scissor mechanisms 80A and 80B to lift the tray clear of the rails 44 and then move the tray by moving the service module (as described above with reference to FIGS. 9A and 9B). At the time of first positioning the service module relative to the tray, the tray will be identified by its RFID chip and the central server will store information relating to the tray according to this identification.

When the tray 12 has reached the desired location, the scissor mechanisms 80A and 80B will lower, thereby placing the tray 12 on a rail 44. The desired location for a tray is determined by the position of the service module as calculated with reference to the optical encoder sensor and the lift positions.

If, for example, it is required to move the tray to one of the rows which is not on the lowest level, then the onboarding lift 26 will move the service module 30 and tray 12 up to the required level. Furthermore, it is to be realised that the rows within the structure 14 act as “first in, first out” queues in that trays are situated within the rows in the order in which they were added to the row. Under normal operations, this will suit the crop growing process since the least mature corps are closest to the onboarding lift 26 and the most mature crops are closest to the offboarding elevator, ready to moved off the structure 14 and taken to the harvesting station 18 at the appropriate time.

However, on occasion it may be necessary to move one or more trays located within a particular row. In this case, the trays preceding or succeeding (depending on which is fewer) will need to be moved first, and the topmost row (which is not provided with lighting or nutrient delivery outlets) is used as a temporary storage for those trays which need to be removed from the row to access the desired tray.

Furthermore, as previously mentioned, the service module will collect information from the camera and other sensors as it moves and the central server is able to correlate that information to particular trays in the structure 14 according to the position of the service module when the images are taken or sensor measurements made. The information collected in this manner may be used to alter lighting, change nutrient compositions, move the tray or take other actions which may lead to a more efficient agricultural process.

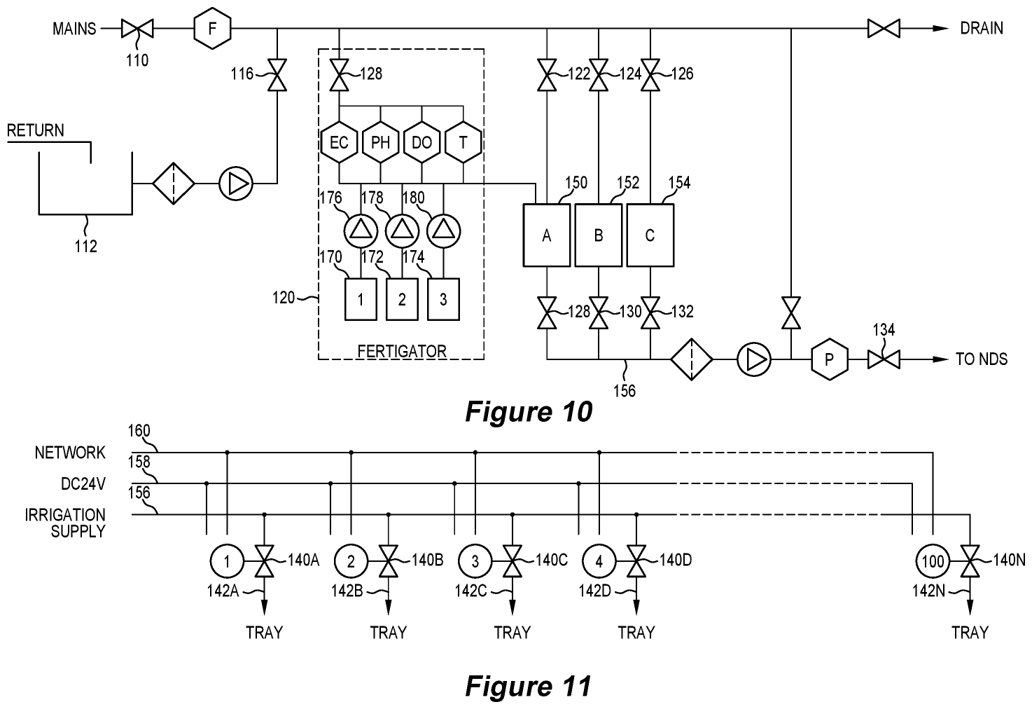

The nutrient delivery system will not be described with reference to FIGS. 9 and 10 which are both hydraulic flow diagrams showing the arrangement for the nutrient delivery system. It is to be realised that the nutrient delivery system includes piping, pumps and reservoirs which may not be illustrated or described. In the Figure, a hexagon denotes a sensor where:
F=Flow Sensor
P=Pressure
EC=Electrical Conductivity.

Water is supplied by the mains at 110 or reservoir 112 which are controlled by respective valves 114 and 116. A ‘fertigator’ 120 comprises three tanks 170, 172 and 174 of different nutrients which can be selectively added to water from the mains 110 or reservoir 112 by operation of the corresponding pumps 176, 78 and 1780 (this fertigator 120 is analogous to the tank 16 illustrated in FIG. 1 and discussed above). Three further supply tanks, “A” 150, “B” 152 and “C” 154 are attached via respective valves to the main line and the nutrient tank 120. The supply tanks 150, 152 and 154 store various components which together make up the nutrient supply for the crops. In this example tank 150 stores a first part of the nutrient mix, tank 152 stores a second part of the nutrient mix and tank 154 stores an acidity regulator. It is necessary to store the nutrient mix in two parts to prevent the mix from degrading. By operation of the various valves then, it is possible to fill the three tanks 150, 152 and 154 with solutions of varying concentration of nutrients.

Valves 128, 130 and 132 connect the tanks 150, 152 and 154 to line 156 which is the line which feeds nutrients to the crops. Therefore, by selective operation of the valves 150, 152 and 154 water with varying concentrations of nutrients can be fed to the crops.

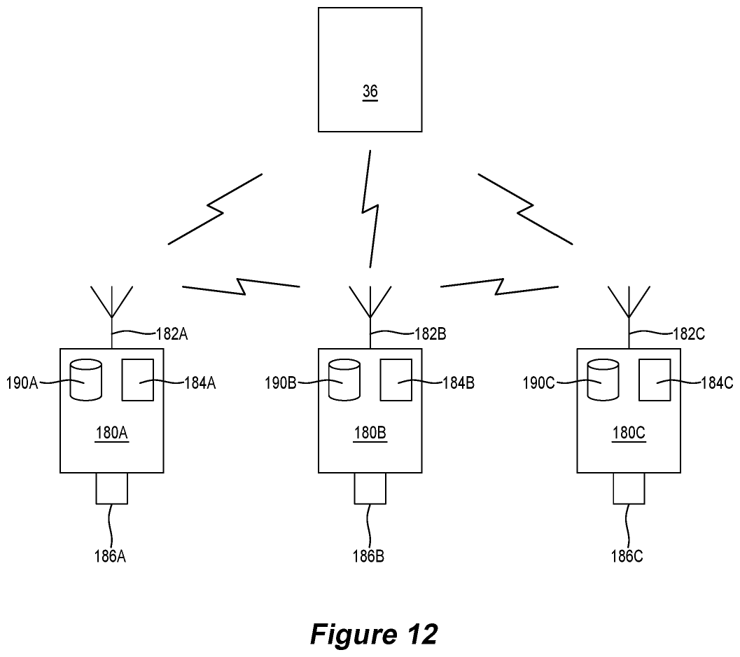

FIG. 11 illustrates the continuation of the line 156 which is connected to a number of outlets 142A, 142B, 142C, 142D, . . . 142N by corresponding valves 140A, 140B, 140C, 140D, . . . 140N. It is to be realised that the outlets 142A, 142B, 142C, 142D, . . . 142N illustrated in FIG. 15 are the same as the outlets 50 illustrated in FIG. 3.

The valves 140A, 140B, 140C, 140D, . . . 140N each comprise a networked controller which is connected to a computer network by communications line 160, which in this embodiment is a 1-Wire Network line. In this embodiment, the 1-Wire Network uses the Maxim 1-Wire protocol, but it is to be realised that many other protocols could be used instead.

Electrical power is provided to the valves via line 158. As illustrated, the valves 140A, 140B, 140C, 140D, . . . 140N are connected in series to the communications line 160. By utilizing a machine readable unique identifier encoded in the networked controller it is possible to address each of the valves individually. Connecting the valves in series may be significantly cheaper and simpler than using a separate connection for each valve. Furthermore, this may be easier to maintain as there are fewer communication lines and connections.

FIG. 12 illustrates an alternate embodiment with valves 180A, 180B and 180C (three are shown for the purposes of illustration, but in practice many more valves are used (for example, one valve per potential tray location may be used).

Each of the valves includes a corresponding wireless antenna 182A, 182B and 182C, and corresponding network hardware and software needed to communicate with the central server 36. Each valve also includes a temperature and humidity sensor 184A, 184B and 184C as well as a sprinkler head 186A, 186B, 186C. The sprinkler head are connected to the liquid nutrients and, the valves control delivery of the nutrients to the trays through the sprinkler heads. In this respect, the valves of embodiment of FIG. 11 would be connected to power (158, FIG. 11) and the irrigation supply (156, FIG. 11).

Each of the valves further comprises internal storage 190A, 190B and 190C for storing data.

During operation of the system, the central server, at predefined periods (for example, every two weeks) will download a schedule of operation to each of the valves in the system. Each valve will store a copy of the schedule in its data store. Then, when a service module places a tray which is to be irrigated by a specific valve, the central server will communicate to the valve for that tray to inform it that there is a tray present. The valve will then switch to an active state and will deliver nutrients according to the stored schedule.

Likewise if a service module removes the tray, this is communicated to the central server which, in turn, informs the corresponding valve that the tray has been removed, and the valve will then switch to an inactive state and will ignore the operation schedule.

In this manner, the network communication between the central server and each valve may be minimized; the amount of information may be significantly less than telling each valve when to deliver nutrients as required. This may allow for significantly more valves in a network and may reduce network overhead and increase speed.

In this embodiment, the network used is a Bluetooth MESH network, but it is to be realised that other wireless and wired networks may also be used.

Referring back to FIG. 11, since each of the valves 140A, 140B, 140C, 140D, . . . 140N (or 180A, 180B and 180C) is separately operable to deliver water and other nutrients to the corresponding tray, and since the line 156 joining the valves 140A, 140B, 140C, 140D, . . . 140N is selectively connectable to the tanks 150, 152 and 156 containing varying concentrations of nutrients, it is possible to deliver a selected concentration to one tray or to a selected set of trays by operating the requisite valves in the system.

As used herein, the term “device” shall not be limited to meaning a unitary entity, but covers both a unitary entity and an entity comprising distinct components whether manually removable, or not.

It is to be understood that, if any prior art publication is referred to herein, such reference does not constitute an admission that the publication forms a part of the common general knowledge in the art, in Australia or any other country.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments. Similarly, the word “device” is used in a broad sense and is intended to cover the constituent parts provided as an integral whole as well as an instantiation where one or more of the constituent parts are provided separate to one another.

1. An agricultural system comprising a plurality of trays, each tray being suitable for holding a substrate in which a crop can grow, a structure for supporting the plurality of trays in a stacked arrangement, the system further comprising a lighting system for delivering light to the crops and a nutrient supply system for supplying nutrients to the crops and at least one service module for lifting a selected tray and for moving the selected tray relative to the frame and the other trays along any one of a plurality of preconfigured paths, wherein the service module comprises an internal power source for powering said lifting of the selected tray and moving of the selected tray along a path.

2. The agricultural system according to claim 1 wherein the structure and the service modules are configured so that the service module is positioned below the selected tray prior to lifting.

3. The agricultural system according to claim 2 wherein the service module comprises a lifter for engaging the selected tray from below and lifting and lowering the selected tray, and wherein the lifter comprises one or more sets of arms arranged in a scissor formation.

4. (canceled)

5. The agricultural system according to claim 1 wherein the stacked arrangement extends both horizontally and vertically.

6. The agricultural system according to claim 1, further comprising a plurality of service modules.

7. The agricultural system according to claim 6 wherein each service module is configured to lift and move a selected tray along a preconfigured path wherein a first preconfigured path for a first service module is distinct from a second preconfigured path for a second service module.

8. The agricultural system according to claim 6 wherein each service module comprises at least one camera, wherein the camera is directed downwards so that the camera is able to capture image information relating to crops located below the service module.

9. (canceled)

10. The agricultural system according to claim 8 wherein the camera captures image information in the visual, ultra-violet and/or infra-red bands.

11. The agricultural system according to claim 1 wherein the service module may comprise one of more of a carbon dioxide sensor, a temperature sensor and a humidity sensor.

12. The agricultural system according to claim 1 wherein each tray comprises a unique label, and wherein the service module comprises a label reader for identifying each tray by the corresponding label.

13. (canceled)

14. The agricultural system according to claim 6 wherein the service modules comprise a locomotion system, the locomotion system comprising a plurality of wheels, at least one of which is powered by the internal power source.

15. The agricultural system according to claim 1 wherein the service module comprises an odometer for measuring a distance travelled by the service module or a blowing arrangement for blowing air downwards as the service module moves.

16. (canceled)

17. The agricultural system according to claim 1 further comprising one or more stations comprising one or more of a harvesting station, a cleaning station and a planting station, and wherein the service module transports the tray between the structure and the one or more stations, and between the stations where there is more than one station.

18. (canceled)

19. The agricultural system according to claim 1 comprising one or more rails defining one or more paths for the service module, wherein the rails additionally act to support the trays within the structure.

20. (canceled)

21. The agricultural system according to claim 6 comprising one or more service module lifts to move the service modules vertically relative to the structure.

22. An agricultural system comprising a plurality of trays, each tray being suitable for holding a substrate in which a crop can grow, a structure for supporting the plurality of trays in a stacked arrangement, the system further comprising a lighting system for delivering light to the crops and a nutrient supply system for supplying nutrients to the crops and at least one service module for lifting a selected tray and for moving the selected tray relative to the frame and the other trays along any one of a plurality of preconfigured paths, wherein the structure and the service modules are configured so that the service module is positioned below the selected tray prior to lifting and wherein the service module comprises a lifter for engaging the selected tray from below and lifting and lowering the selected tray.

23. (canceled)

24. (canceled)

25. (canceled)

26. (canceled)

27. A method of moving a tray within an agricultural system, the agricultural system comprising a plurality of trays, each tray being suitable for holding a substrate in which a crop can grow and a structure for supporting the plurality of trays in a stacked arrangement, the system further comprising a lighting system for delivering light to the crops and a nutrient supply system for supplying nutrients to the crops and at least one service module, the method comprising lifting a selected tray from below using a service module positioned below the tray and using the service module to move the selected tray relative to the frame and the other trays along any one of a plurality of preconfigured paths.

28. The method according to claim 27 wherein the structure extends both vertically and horizontally, the structure defining the plurality of preconfigured paths, at least one of which comprises a vertical component, wherein the method comprises lifting the tray to follow the vertical component of the preconfigured path.

29. The method according to claim 27 further comprising using the service module to collect data relating to the agricultural system while the service module moves through the system, wherein the data collected by the service module may include one or more of images, temperature, carbon dioxide concentration, lighting intensity and/or colour, humidity, etc.

30. (canceled)

31. The method according to claim 27 wherein the service module further comprises a blower, the method further comprising blowing air downwards using the blower as the service module moves through the structure.

32. (canceled)

33. (canceled)

34. (canceled)

35. (canceled)

36. (canceled)
